(19) United States
(12) Patent Application Publication
(10) Pub. No.: US 2014/0095204 A1
(43) Pub. Date: Apr. 3, 2014

(54) AUTOMATED MEDICAL COHORT DETERMINATION

(71) Applicants: Glenn Fung, Madison, WI (US); Balaji Krishnapuram, King of Prussia, PA (US); Faisal Farooq, Norristown, PA (US); Shipeng Yu, Exton, PA (US); Bharat R. Rao, Berwyn, PA (US); Vikram Anand, Downingtown, PA (US)

(72) Inventors: Glenn Fung, Madison, WI (US); Balaji Krishnapuram, King of Prussia, PA (US); Faisal Farooq, Norristown, PA (US); Shipeng Yu, Exton, PA (US); Bharat R. Rao, Berwyn, PA (US); Vikram Anand, Downingtown, PA (US)

(73) Assignee: SIEMENS MEDICAL SOLUTIONS USA, INC., Malvern, PA (US)

(21) Appl. No.: 14/037,469

(22) Filed: Sep. 26, 2013

Related U.S. Application Data
(60) Provisional application No. 61/707,267, filed on Sep. 28, 2012.

(51) Int. Cl. G06F 19/00

(52) U.S. Cl. CPC G06F 19/345; G06F 19/322
USPC 705/3

(57) ABSTRACT

Inclusion of a patient in a medical category is determined by triggering an analysis of an electronic medical record of the patient in response to an input of data into the electronic medical record. Identifying characteristics that indicate inclusion in the medical category with the analysis, and determining a probability the patient belongs to the medical category based on the identified characteristics.

### RELATED APPLICATIONS

The present patent document claims the benefit of the filing date under 35 U.S.C. §119(e) of Provisional U.S. Patent Application Ser. No. 61/707,267, filed Sep. 28, 2012, which is hereby incorporated by reference.

### BACKGROUND

The present embodiments relate to medical cohort determination. Specifically, the present embodiments relate to automatic medical category determination based on patient current and historical data.

Medical category determination early in the course of treatment of a patient can provide the patient a more specific and directed course of treatment that can allow for a more efficient treatment of the patient, and a faster patient recovery time. Medical category determination may involve manual medical chart review by a medical expert and tends to be a resource intensive, human-labor driven, activity. As the volume of patients increase for a facility, the workload for the medical experts and professionals tasked with determining medical categories for patients increases, and a determination for a particular patient may become delayed, or subject to human error. Also, upon admission of a patient to a medical entity, there is not always an opportunity to manually review an entire medical history of a patient, and medical category determination at admission may be limited to information specifically provided by a patient during the admission process.

Electronic Medical Records (EMR) have become the standard storage technique for medical and health records for patients of medical practitioners and medical entities. EMRs contain a considerable amount of medical data for specific patients, from various sources and in various formats. Collections of EMRs for medical facilities provide medical records and history for most, if not all, patients in a medical entity.

### BRIEF SUMMARY

By way of introduction, the preferred embodiments described below include methods, computer readable media, and systems for automated patient medical category determination. The probability that a patient belongs in a particular cohort or category is determined. An action may be recommended based on the determined probability.

In a first aspect, a method is provided for determining inclusion of a patient in a medical category. An analysis of an EMR is triggered by a processor in response to an input of data into an EMR. Characteristics are identified that indicate inclusion in the medical category based on the analysis. A probability is determined by the processor that the patient belongs to the category based on the identified characteristics. An action to undertake may be recommended based on the probability.

In a second aspect, a non-transitory computer readable storage medium has stored therein data representing instructions executable by a programmed processor for determining inclusion of a patient in a medical category. The storage medium includes instructions for triggering an analysis of an electronic medical record of the patient in response to an input of data into the electronic medical record, identifying characteristics that indicate inclusion in the medical category with the analysis, determining a probability the patient belongs to the medical category based on the identified characteristics, and recommending an action to undertake based on the probability.

In a third aspect, a system is provided for determining inclusion of a patient in a medical category. A memory is operable to store a plurality of electronic medical records of a plurality of patients of a medical entity and a specific electronic medical record of the patient. A processor is configured trigger an analysis of the specific electronic medical record in response to an input of data into the specific electronic medical record, identify characteristics that indicate inclusion in the medical category with the analysis, determine a probability the patient belongs to the medical category based on the identified characteristics, and recommend an action to undertake based on the probability.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a flow chart diagram of an embodiment of a method for determining inclusion of a patient in a medical category;

FIG. 2 is a block diagram of one embodiment of a system for determining inclusion of a patient in a medical category; and

FIG. 3 is a representation of an electronic medical record.

### DETAILED DESCRIPTION OF THE DRAWINGS AND PRESENTLY PREFERRED EMBODIMENTS

Rather than requiring a manual review of a patient medical record, patient medical category determination may be determined automatically by leveraging the specific EMR of the patient and the EMRs of other patients of a medical entity.

In several applications related to clinical workflow, ambulatorial medical care and biomedical research, automatic identification of patient cohorts with particular relevant characteristics, or a medical category, is desired. These characteristics may include diagnosis, conditions, symptoms, or any other characteristic that may indicate inclusion in a medical category. Automatic identification of subsets of patients with particular clinical attributes that can concurrently stratify patients on the basis of a given criteria of clinical interest, such as risk factors or chronic conditions, may have a large impact in assisting medical professionals to make crucial decisions related to medical care. Some of the possible applications where automatic medical category identification is relevant may include clinical decision support, quality of care surveillance, pharmacovigilance, or identification of prospective subjects for a research study or clinical trials.

The case of medical category determination for clinical trials may be important financially as medical entities may be required to perform certain tasks within a certain amount of time depending on a medical category determined for a patient upon admission to the medical facility. For example, patients in an Acute Myocardial Infarction medical category may be required to be administered a dose of acetylsalicylic acid within 24 hours of admission to a medical entity. If a medical entity does not comply with the clinical trial requirement, a financial incentive for the medical entity may be at risk. In such an example, early identification of a medical category for a patient may allow for the initiation of a workflow that enforces compliance with regulations for the particular medical category.

As more medical data becomes computerized, more data becomes available for analysis and may be used in new ways. This also creates opportunities to integrate and use patient data coming from new and different sources, for example structured and unstructured data, for medical category determination. Some of the new sources for data may include physician and nurse handwritten notes, lab data, billing data, demographic data, image data, and any other data that may contribute to indicating inclusion in a medical category.

A clinical system may provide for concurrent predictive decision support to enable medical practitioners and researchers to rapidly, accurately, and inexpensively identify a medical category of interest automatically. The system may predict the probability of belonging to a predefined medical category for a patient based on data in an electronic medical record. The medical category may be defined by a user, or determined automatically. The system may involve performing the predictions in a concurrent way. For example, the system may use information currently available to predict the likeliness of a patient belonging to a medical category. Further, as new data is entered for a patient, the system may evaluate this data for relevance to medical category determination, and use the entered information to improve the quality of a medical category prediction.

The system may learn to group patients in a newly defined medical category based on a presented example electronic medical record for the medical category. For example, a medical practitioner may choose a group of electronic medical records that belong to a medical category to be defined, and the system may assign probabilities of other electronic medical records belonging to the same medical category. The predictive capability of the system may be improved by presenting new electronic medical records to a system user, wherein the system user may label the presented medical records as either in the medical category, or not in the medical category. The system may further involve predefined models for common medical categories such as Acute myocardial infarction, heart failure, and pneumonia. The predefined models may be developed from existing clinical knowledge or collections of electronic medical records.

The system may involve a machine learning model that may make predictions with incomplete data in a concurrent fashion. The machine learned models may learn from a database of electronic medical records and/or prior clinical knowledge to represent and efficiently manipulate a probability distribution that a patient may belong to a medical category. The probability may be based primarily on currently available information for a patient such as information in an electronic medical record from previous patient examinations, lab determined values, demographics, or a current primary symptom complaint by a patient, or any other data that may help in the probability determination. Information such as a current primary symptom complaint may be input into an electronic medical record, and trigger an analysis regarding applicable medical categories, with the input. As more information is entered, the model may run continuously to update a probability based on the new information. This sort of predictive model may be created using various techniques. In an embodiment, the technique involves a generative probabilistic model such as a Bayes net or Markov Random fields model. The model may represent relations among medical concepts, terms and information and the likelihood of membership in a medical category for a patient.

In an embodiment, a model may be trained using a dataset containing data from patients in the medical category and patients from a general clinical population, not in the medical category. Labels may be used to identify membership in a medical category. A graphical model may be created that models the conditional probability of medical category membership given the available data. A joint probability distribution among data features may also be modeled. In this way, current available data alone may provide for a prediction based on a probability of membership in the medical category.

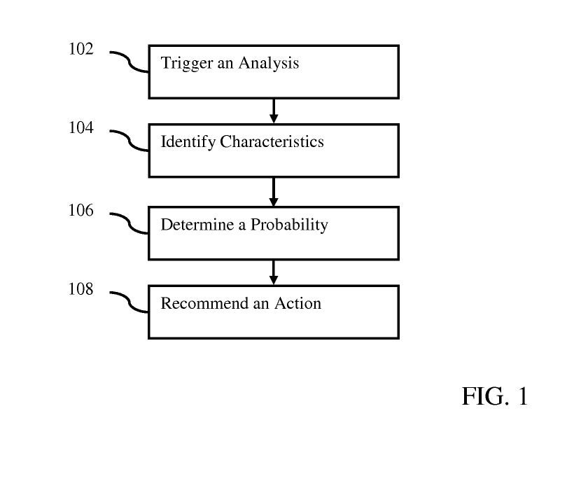

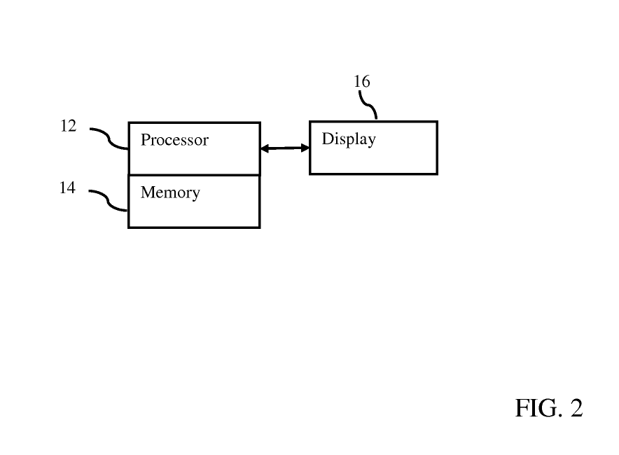

FIG. 1 shows a method for determining inclusion of a patient in a medical category. The method is implemented by a computerized physician order entry (CPOE) system, an automated workflow system, a review station, a workstation, a computer, a picture archiving and communication system (PACS) station, a server, combinations thereof, or other system in a medical facility. For example, the system or computer readable media shown in FIG. 2 implements the method, but other systems may be used. Additional, different, or fewer acts may be performed. For example act 108 may not be provided. The method is implemented in the order shown or a different order. For example, acts 104 and 106 may be performed in parallel.

In act 102, an analysis of an electronic medical record for a patient is triggered in response to an input of data into the EMR. The analysis may be triggered by the input of any type of data into the EMR. For example, any data relating to a characteristic that may be used to determine a medical category for a patient triggers analysis. In an embodiment, physician notes, nurse notes, or laboratory data may trigger the analysis. For example, the entry of a specific combination of prescription drugs may indicate that a patient belongs to a particular medical category. The triggering data may be structured, such as a form field, or unstructured, such as hand written notes scanned and entered into an EMR. For example, a physician may hand write a prescription for a combination of drugs that indicate the inclusion of the patient in a category. Other, non-clinical data may also trigger the analysis, such as demographic or billing data.

In an embodiment, the triggering is repeated for all new data input into the EMR. The triggering may be restricted to entry of values for certain or a limited number of variables. In an embodiment, the triggering is repeated for data input into critical categories, or categories determined to generally have a high likelihood of including or indicating a characteristic.

Alternatively, the triggering is periodic or in response to user activation without entry of new or additional data. Other triggers in addition to or alternative to data entry in an EMR may be used.

In act 104, characteristics that indicate inclusion in a medical category are identified with, or based on, the analysis triggered in act 102. In an embodiment, the triggered analysis is performed on historical data in an EMR and the input triggering data. The historical data is data already existing in the EMR. All or only some of the historical data may be used. In other embodiments, only the data input at the time of triggering is used in the analysis.

The characteristics may be any type of characteristic. In an embodiment, a characteristic may be a diagnosis, condition, or a symptom. For example, a symptom of excessive thirst may be a characteristic that indicates a medical category of diabetes.

In an embodiment, the characteristics are characteristics or combinations of characteristics identified for specific medical categories. The characteristics of the specific medical categories may be known, and a system may be specifically configured to identify those characteristics. For example, excessive thirst, weight loss, and fatigue may be characteristics indicating a medical category of diabetes. An embodiment may involve a specific identification protocol for these characteristics. Identifying the characteristics may involve multiple tests from multiple different examinations over time. For example, weight loss is difficult to detect with a singular reading. However, in act 104 weight loss may be identified by comparing a weight currently entered into an EMR with a previous weight entered into an EMR. This determined weight loss may in this way be a characteristic determined from a combination of data over time. Other predetermined categories may include, but not be limited to, acute myocardial infarction, heart failure, or pneumonia. Each category has specific characteristics to be identified, if available.

A characteristic may be identified from historical data of a patient, such as data existing in a patient's EMR. The historical data of an EMR may be mined to determine characteristics. The hand written prescription may be scanned into the EMR and be input data. Any data mining may be used, such as disclosed in U.S. Pat. No. 7,617,078.

Characteristics to be identified may be determined by any method. In an embodiment, known clinical standards and diagnosis criteria are used. In an embodiment, characteristics are learned through a machine learned model. For example, a machine learning model may be provided EMRs of known members of a medical category from an EMR database of one or more medical entities. The machine learned model may then analyze the known EMRs to determine common or relative characteristics that indicate inclusion in the medical category. Discriminative characteristics are learned by the machine. The machine learned model may also be provided EMRs of patients known not to be in the medical category to further establish the discriminative characteristics of the medical category.

In act 106, a probability that a patient belongs to a medical category is determined based on the identified characteristics of act 104. The probability may be determined based on any probabilistic model. For example, a Bayes net model or a Markov random fields model may be used. In an embodiment, a generative probabilistic model is applied to EMRs in a medical database of a medical entity to determine probabilities based on combinations of existences of characteristics in EMRs of the medical category. A probability may be determined or expressed as a score, ranking, likeliness, assessed presumption, or any other indication of a probability that a patient belongs to a medical category.

The matrix or other representation of the machine learnt classifier may be the same one used to determine the discriminative characteristics. By inputting values for the discriminative characteristics, the classifier outputs a probability.

In an embodiment, characteristics needed to determine inclusion in a medical category with a desired certainty are established. For example, excessive thirst, fatigue and weight loss are characteristics determined for a patient. There may be other characteristics that indicate inclusion in a diabetes category, such as blurred vision, high blood pressure, or slow healing sores, but the identification of excessive thirst, fatigue, and weight loss may determine inclusion in a diabetes category within a desired certainty. In another example, excessive thirst and fatigue may be the characteristics identified from an EMR. A diabetes category determination may involve excessive thirst, fatigue, and weight loss. The weight loss is missing from the EMR. The resulting predicted probability may be weighted or otherwise account for the missing information. In one embodiment, characteristics are weighted or scored and a probability is based on a characteristic determined by the analysis. For example, a diabetes category determination may weigh weight loss at 50%, excessive thirst at 30% and fatigue at 20%. In another example, equal weighting may be used. In this example, a probability of inclusion in the diabetes category for a patient with excessive thirst and fatigue characteristics may be 50%. The magnitude of change of a characteristic, or a value for a characteristic, may be used to determine the probability. For example, a weight loss value found to be 10% may predict a higher probability for inclusion in a diabetes category than a 5% weight loss. Also, the weighting of factors may be based on a value for a characteristic. In the previous example, the 10% weight loss may be weighed heavier as a weight loss characteristic than the 5% weight loss.

A probability determination may be any qualitative or quantitative score. For example, the probability determination may be a statistical probability of inclusion in a medical category, from 0% to 100%. In another embodiment, the probability determination may include a qualitative description of the probability, such as “low probability”, “medium probability”, or “high probability”.

In addition or alternative to a probability, a conclusion may be determined. It may be determined whether or not a patient is in a medical category. The determined probability is compared to a threshold. The threshold may be predetermined, or determined based on an average value in the medical category determined for a group of EMRs in a medical category. In an embodiment, a probability of 100% may determine that a patient belongs to a medical category.

Probability determinations may be updated, or recalculated as more information for a patient is input into an EMR. As such, a probability may be continuously dependent on the information currently available to the system, and updated as new information is input. Also, a patient may have probabilities of belonging to multiple medical categories determined. The likelihood of inclusion in each or any of the multiple categories may be updated as information is added to the system. As such, the probabilities determined for inclusion in medical categories for a patient may indicate that a patient belongs to multiple medical categories.

In act 108, an action may be recommended based on the probability determined in act 106. In an embodiment, the probability may indicate a strong or sufficient likelihood of inclusion in a medical category, and a procedure to verify inclusion in the medical category, such as a blood test or other clinical determinative measure, may be recommended. Where a value for a characteristic used by the classifier is missing, a recommendation to obtain a value for that characteristic is obtained. In one embodiment, a medical workflow may be modified to include a recommended procedure. The recommended action may involve contacting a medical specialist in the field of the medical category. In an embodiment, the recommended action may be to assign the medical category to the EMR of the patient.

The recommended action may also be a series of procedures incorporating a recommended or preferred care plan for patients in the medical category. The recommended action may involve multiple options for a course of treatment for a patient, based on the determined probability. In an embodiment, each optional course of treatment may be associated with a possible probability of the patient belonging to a medical category that may be determined based on the results of each course of treatment. For example, three options for treatment may be presented. Each option may be associated with a possible probability of inclusion in the medical category after the treatment option. The determined probability that the patient belongs to a medical category may be 75%. One treatment course option may indicate that the possible probability of belonging to the medical category after the treatment may be 35%. A different treatment course option may indicate a possible probability of 42%. The third treatment course option may indicate a possible probability of 29%. The possible probability may be determined using existing EMRs of patients of the facility and data from an EMR of the patient. The possible probability may be based on the EMRs of patients determined to be in the medical category before and after the patients underwent the various treatment options. In another embodiment, the treatment options may be courses of treatment intended to verify inclusion in a medical category.

In an embodiment, the value of a determined probability may indicate different suggested actions for the same medical category. For example, if a determined probability is 30% that a patient belongs to a diabetes category, nutritional training may be a recommended action. If a determined probability is 80%, however, further medical procedures or testing may be the recommended action.

A current patient may be determined to belong to a medical category. The EMR of the current patient may be used to further train or update a system intended to identify characteristics indicating medical categories. New characteristics for a medical category may be added for determining a medical category from the current patient EMR. In an embodiment, a current patient EMR used as a training EMR for a machine learned model to determine characteristics indicating a medical category. The current patient EMR may be a singular training EMR, or it may be combined with historical EMRs of other patients to determine characteristics for medical categories. In an embodiment, an EMR of a patient that has been determined to belong to a medical category based on a determined probability is automatically used as a training EMR for that category. In this way, determining characteristics for medical categories, and ultimately determinations for inclusion in medical categories, may be continually updated.

FIG. 2 shows a system for determining inclusion of a patient in a medical category. The system is a server, network, workstation, computer, database, or combinations thereof. The system 10 includes a processor 12, a memory 14, and a display 16. Additional, different, or fewer components may be provided. For example, the system includes a scanner, a network connection, a wireless transceiver or other device for receiving patient information and/or communicating patient information to other systems. A wireless transceiver may allow for communication with a physician's mobile device for displaying information such as a recommended action to undertake based on a determined probability that a patient is a member of a medical category. The physician may also enter information relating to the patient, using the mobile device, into an EMR, which may trigger an analysis of the EMR. The data may be received and processed in or outside of the medical facility setting. For example, a physician writes an order for a prescription on a mobile device while in a hospital or at home. The prescription is transmitted to a server outside or in the hospital to be input into an EMR.

The memory 14 is a buffer, cache, RAM, removable media, hard drive, magnetic, optical, database, or other now known or later developed memory. The memory 14 is a single device or group of two or more devices. The memory 14 is shown within the system, but may be outside or remote from other components of the system, such as a database or PACS memory.

The memory 14 stores an EMR for a patient. Multiple EMRs of other patients may also be stored on the memory 14. In an embodiment, the memory 14 is operable to store a plurality of electronic medical records of a plurality of patients of a medical entity and a specific electronic medical record of the patient.

The memory 14 is additionally or alternatively a non-transitory computer readable storage medium with processing instructions. The memory 14 stores data representing instructions executable by the programmed processor 12 for determining a medical category for a patient. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The processor 12 is a server, general processor, digital signal processor, graphics processing unit, application specific integrated circuit, field programmable gate array, digital circuit, analog circuit, combinations thereof, or other now known or later developed device for medical category determination. The processor 12 is a single device, a plurality of devices, or a network. For more than one device, parallel or sequential division of processing may be used. Different devices making up the processor 12 may perform different functions, such as a handwriting detector by one device and a separate device for communicating or processing the detected handwritten data. In one embodiment, the processor 12 is a control processor or other processor of a computerized data entry system for an EMR storage or database system. The processor 12 operates pursuant to stored instructions to perform various acts described herein.

The processor 12 is configured by software or hardware to determine a medical category for a patient. The processor 12 may be configured to trigger an analysis of the specific electronic medical record in response to an input of data into the specific electronic medical record stored in memory 14. The processor 12 may be further configured to identify characteristics that indicate inclusion in the medical category with the analysis, determine a probability the patient belongs to the medical category based on the identified characteristics, and inclusion of the patient in the medical category based on the probability.

The display 16 is a CRT, LCD, plasma, projector, printer, or other output device for showing an image. The display 16 displays a user interface with an image. The user interface may be for the entry of information, such as information that may be characteristics that indicate the inclusion of a patient in a medical category. The user interface may be for entering information into an EMR. The user interface may display a probability or binary conclusion for membership in a category. The probability of membership in more than one category may be displayed.

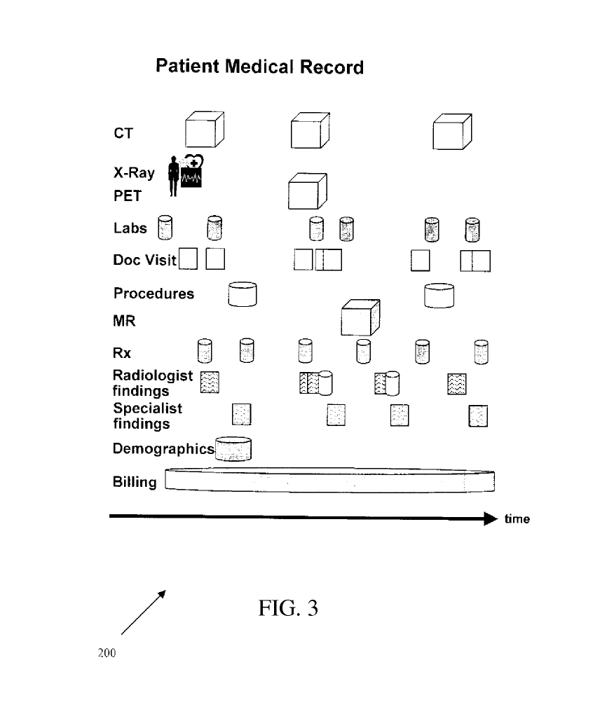

FIG. 3 shows an exemplary EMR 200. Health care providers may employ automated techniques for information storage and retrieval. The use of an EMR to maintain patient information is one such example. As shown in FIG. 3, an exemplary EMR 200 includes information collected over the course of a patient's treatment or use of an institution. This information may include, for example, computed tomography (CT) images, X-ray images, laboratory test results, doctor progress notes, details about medical procedures, prescription drug information, radiological reports, other specialist reports, demographic information, family history, patient information, and billing(financial) information. Any of this information may provide for a characteristic, or data indicating a characteristic, that may be used to determine a medical category for a patient.

An EMR may include a plurality of data sources, each of which typically reflects a different aspect of a patient's care. Alternatively, the EMR is integrated into one data source. Structured data sources, such as financial, laboratory, and pharmacy databases, generally maintain patient information in database tables. Information may also be stored in unstructured data sources, such as, for example, free text, images, and waveforms. Often, characteristics, such as key clinical findings, are only stored within unstructured physician reports, annotations on images or other unstructured data source.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A method of determining inclusion of a patient in a medical category, the method comprising:
triggering, by a processor in response to an input of data into an electronic medical record of the patient, an analysis of the electronic medical record;
identifying characteristics that indicate inclusion in the medical category with the analysis;
determining, by the processor, a probability the patient belongs to the medical category based on the identified characteristics; and
recommending an action to undertake based on the probability.

2. The method of claim 1, wherein the analysis comprises analyzing historical data from the electronic medical record and the data input into the electronic medical record.

3. The method of claim 1, wherein identifying comprises identifying the characteristics through an analysis of a plurality of electronic medical records of a medical entity, wherein the analysis is through a machine learned model.

4. The method of claim 1, wherein identifying the characteristics comprises identifying a diagnosis, a condition, or a symptom.

5. The method of claim 1, wherein identifying comprises identifying for inclusion in the medical category comprising an acute myocardial infarction category, a heart failure category, or a pneumonia category.

6. The method of claim 1, wherein triggering comprises triggering in response to the input of physician notes, nurse notes, laboratory data, demographic data, or billing data.

7. The method of claim 6, wherein triggering comprises triggering in response to the input of unstructured data.

8. The method of claim 1, wherein determining a probability comprises applying a generative probabilistic model based on electronic medical records of previous patients of a medical entity.

9. The method of claim 8, wherein applying the generative probabilistic model comprises applying a Bayes net model or a Markov random fields model.

10. The method of claim 1, wherein the probability is a value between 1% and 99%.

11. The method of claim 1, further comprising determining whether or not the patient is included in the medical category based on a comparison of the probability to a threshold.

13. The method of claim 1, wherein recommending comprises recommending an update to a medical workflow, a procedure to verify inclusion in the medical category, or a notification of a medical specialist in the medical category.

14. A system for determining inclusion of a patient in a medical category, the system comprising:
at least one memory operable to store a plurality of electronic medical records of a plurality of patients of a medical entity and a specific electronic medical record of the patient;
a first processor configured to:
trigger an analysis of the specific electronic medical record in response to an input of data into the specific electronic medical record;
identify characteristics that indicate inclusion in the medical category with the analysis;
determine a probability the patient belongs to the medical category based on the identified characteristics; and
recommend an action to undertake based on the probability.

15. The system of claim 14, wherein the analysis comprises analyzing historical data from the electronic medical record and the data input into the electronic medical record.

16. The system of claim 14, wherein the first processor is further configured to identify the characteristics through the analysis of a plurality of electronic medical records of a medical entity, wherein the analysis is through a machine learned model.

17. The system of claim 14, wherein the first processor is configured to determine a probability by applying a generative probabilistic model based on electronic medical records of previous patients of a medical entity.

18. The system of claim 14, wherein the first processor is further configured to determine whether or not the patient is included in the medical category based on a comparison of the probability to a threshold.

19. The system of claim 14, wherein the first processor is configured to recommend a procedure to verify inclusion in the medical category, or recommend a notification of a medical specialist in the medical category.

20. A non-transitory computer readable storage medium having stored therein data representing instructions executable by a programmed processor for determining inclusion of a patient in a medical category, the storage medium comprising instructions for:
triggering an analysis of an electronic medical record of the patient in response to an input of data into the electronic medical record;
identifying characteristics that indicate inclusion in the medical category with the analysis;
determining a probability the patient belongs to the medical category based on the identified characteristics; and
determining whether the patient is included in the medical category based on the probability.
